(19) United States
(12) Patent Application Publication
(10) Pub. No.: US 2002/0066350 A1
(43) Pub. Date: Jun. 6, 2002

(54) Structure of a punch system

(76) Inventor: Tom Chiang, Tou Liu City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/726,349

(22) Filed: Dec. 1, 2000

(51) Int. Cl. B26D 5/08

(52) U.S. Cl. 83/631; 83/588

(57) ABSTRACT

A structure of a punch system comprises a punch head set, a linking gear, and an activating board. Wherein the punch head set comprises a series of cutters at bottom and teeth along the two inner sides. The linking gear is formed with a gear wheel and an idle gear in the same shaft. The idle gear is sleeved in the punch head set and meshes with the teeth of the punch head set. The activating board also comprises teeth extending along two sides vertically and meshes with the gear wheel, thus by pressing the activating board, the gear wheel, the idle gear and the punch head set are both linked to decent, simultaneously.

### FIELD OF THE INVENTION

This invention relates to a structure of a punch and bind system, and more particularly to a structure utilizing gear meshing mechanism to move a cutter set up and down.

### BACKGROUND OF THE INVENTION

A conventional punch mechanism mostly uses leveling principle with a handle, this design saves time and energy, however, the long arm takes a lot of space and may be hit by people accidentally.

### SUMMARY OF THE INVENTION

It is the primary object of the present invention to provide a renovated structure of a punch system, which is compact in size and easy to operate.

It is another object of the present invention to provide a renovated structure of a punch system, which is more solid.

It is a further object of the present invention to provide a renovated structure of a punch system, which is inexpensive in production.

### BRIEF DESCRIPTION OF THE DRAWINGS

FIG. 1 is an exploded view of the present invention;

FIG. 2 is a front view of FIG. 1;

FIG. 3 is a perspective view of the present invention in a first state; and

FIG. 4 is a perspective view similar to FIG. 3 in a second state.

### DETAILED DESCRIPTION OF THE PREFERRED EMBODIMENT

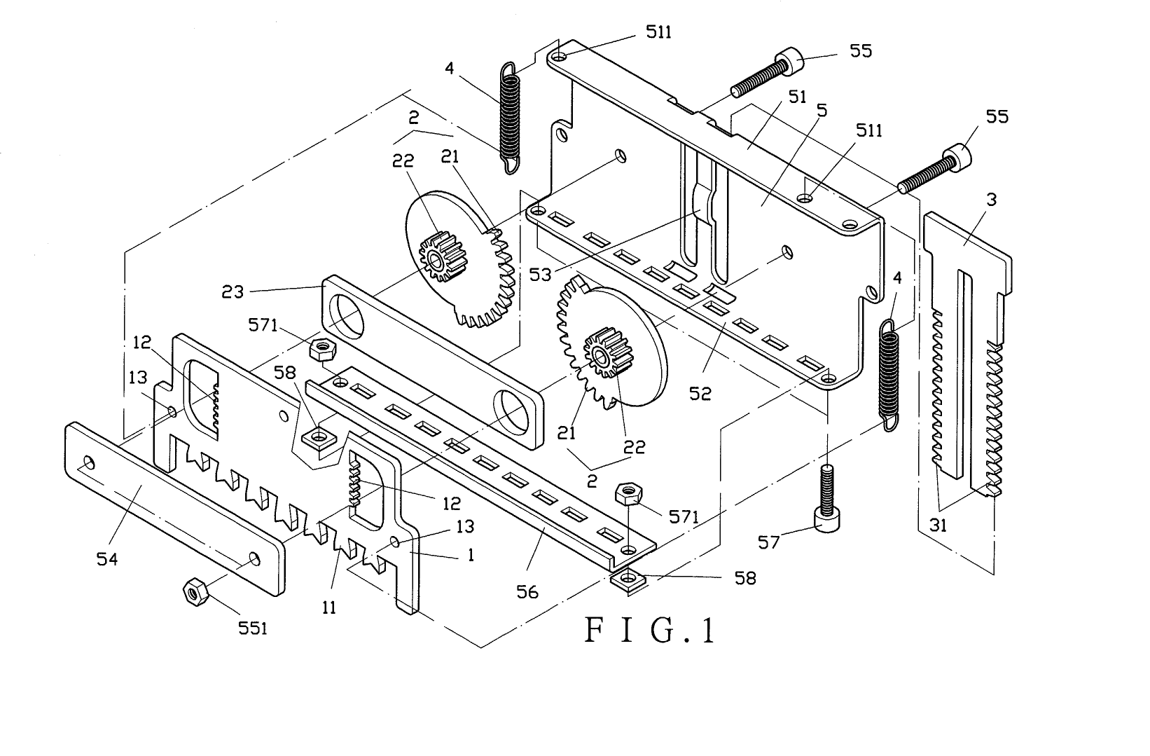

The structure of a punch system of the present invention, as shown in FIG. 1, comprises a punch head set 1, a linking gear 2, an activating board 3, a spring 4 and a cutter set 5.

The punch head set 1 comprises cutters 11 underneath, two sets of teeth 12 being formed on respective sides of the punch head set 1, a pair of holes 13 being formed on respective sides of the punch head set 1 for securing one end of the spring 4.

The linking gear 2 comprises a gear wheel 21 and an idle gear 22 in the same shaft. The wheel gear 21 comprises only partial teeth on one inner edge, and the other side is an arc. The idle gear 22 is inserted through a washer 23.

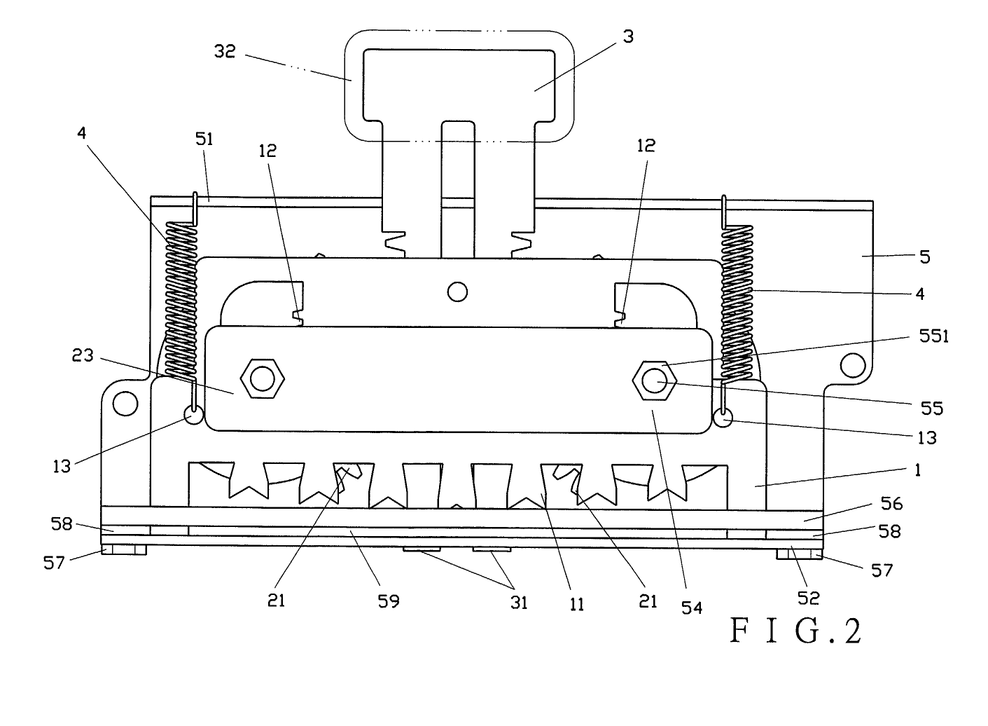

The activating board 3 is a longitudinal board having a pair set of teeth 31 on respective sides, and a handle 32 (as shown in FIG. 2) on top thereof adapted for easy operation.

The cutter set 5 is a board member having a transverse frame 51 on one side, and a hole punch 52 at the other side. The transverse frame 51 has holes 511 adapted to secure the end of the spring 4 against the end connected to the hole 13 of the punch head set 1. The center of the cutter set 5 is formed a guide 53. The cutter set 5 has a front fixture 54 with holes at respective sides adapted to secure all parts together by means of nuts 55 and bolts 551. The hole punch 52 underneath the cutter set 5 is secured with a washer 58 and a guide board 56 by means of bolts 57 and nuts 571 for assembly of the hole punch 52, the washer 58, and the punch head set 1, and for stability of the punch head set 1.

FIG. 2 has shown an assembled system, the linking gear 2 is secured in the cutter set 5, and the activating board 3 is inserted through the transverse frame 51 with the center between the set of teeth 31 sleeved on the guide 53. The teeth 31 of the activating board 3 is meshing with the teeth of the wheel gear 21. The cutter 11 of the punch head set 1 is inserted through the hole punch 52 and the guide board 56, and sealed with the washer 58 to the punch head set 1 by bolts 57 and nuts 571. A paper tray 59 is formed in between the hole punch 52 and the guide board 56 by the thickness of the washer 58. The idle gear 22 is sleeved through a washer 23 and then meshes with the teeth 12 of the punch head set 1 which is covered by the front fixture 54 and secured to the cutter set 5. The two ends of the spring 4 are connected to the hole 511 of the transverse frame 51 and the hole 13 of the punch head set 1, respectively. Thus, when lifting the punch head set 1, the cutter 11 will be positioned above the guide board 56 and the paper tray 59 is formed for paper to be inserted therein.

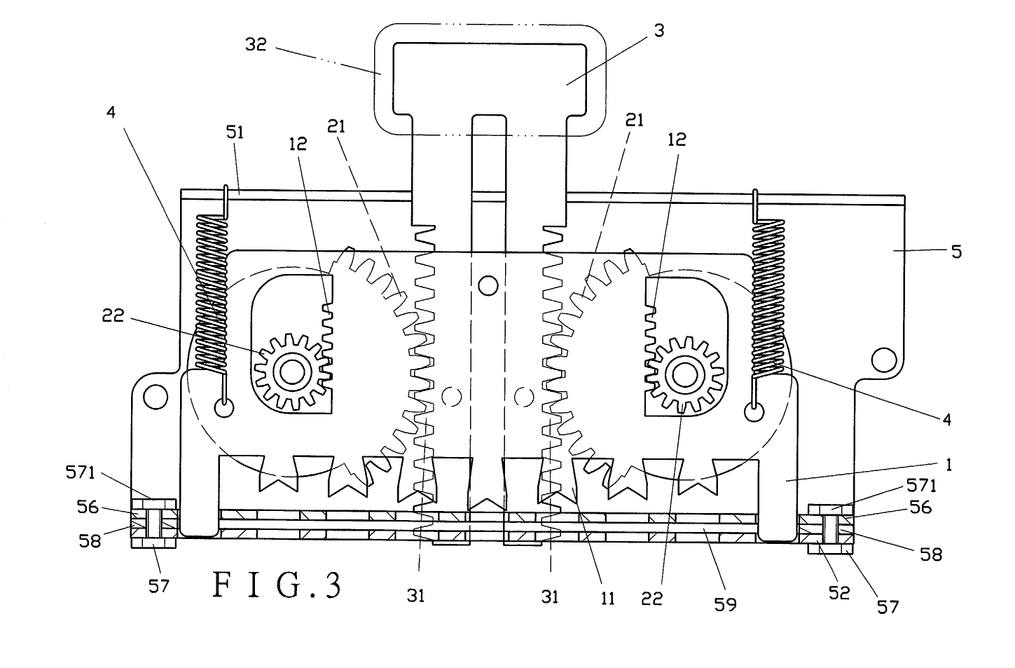

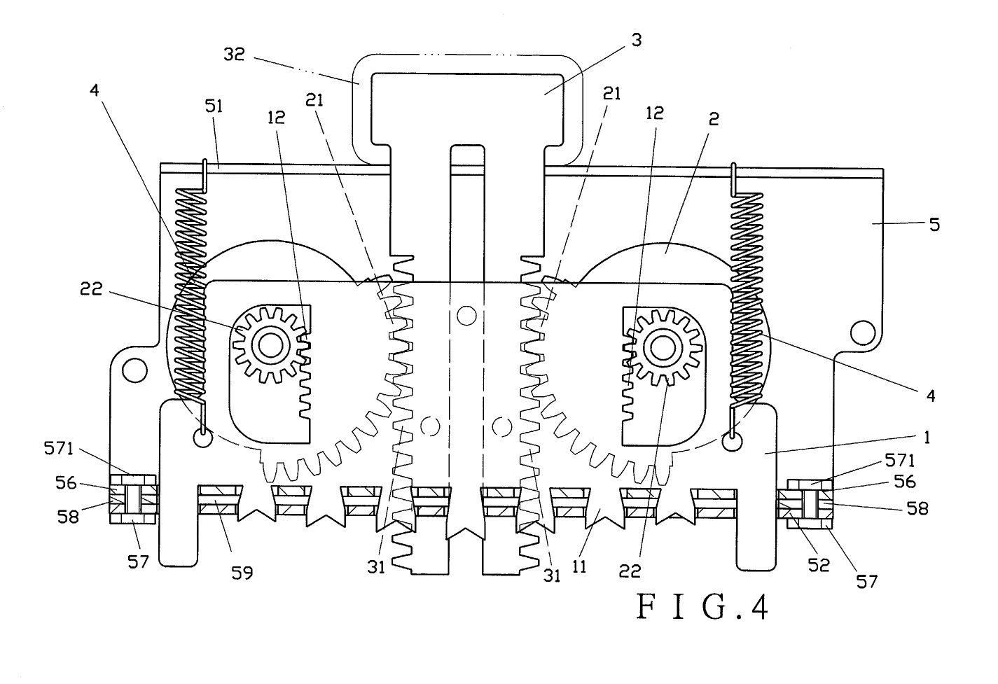

As shown in FIGS. 3 and 4, before pressing down the activating board 3, the spring 4 is always in the position to pull the cutter 11 upward to prevent the punch head set 1 from descending out the guide board 56 and interfering paper to be inserted into the paper tray 59. In operation, first insert paper into the paper tray 59 and then press the handle 32 of the activating board 3 downward, the teeth 31 meshes the gear wheel 21 of the linking gear 2, and the idle gear 22 meshes the teeth 12 of the punch head set 1, which links the cutter 11 to go down simultaneously until the cutter 11 punch holes on 15 the paper and extending there through. Release the activating board 3, the elastic force of the spring 4 will urge the punch head set 1 to lift upwardly.

I claim:

1. A structure of a punch system comprising a punch head set, a linking gear and an activating board, wherein
said punch head set comprising cutters at bottom edge and teeth at respective inner sides;
said linking gear comprising a wheel gear, and an idle gear, wherein said idle gear being inserted through said punch head set and meshing with said teeth of said punch head set;
said activating board comprising teeth meshing with said wheel gear;
thus, by pressing said activating board downward, said linking gear links said punch head set to punch holes on paper.

2. A structure of a punch system, as recited in claim 1, further comprises two springs and a cutter set, wherein
said cutter set comprising holes at respective sides for securing one end of each spring;
said cutter set comprising a transverse frame and a hole punch, the top portion of said transverse frame being formed with holes at respective sides for securing an end of said springs opposing the end securing to said hole of said cutter set, the center portion of said transverse board being formed with a guide, said cutter set further comprising a front fixture, bolts and nuts, said hole punch underneath said cutter set being secured to said guide board and said punch head set by means of bolts and nuts, between said hole punch and said guide board being secured with a washer to maintain a space as a paper tray, and wherein said activating board having its teeth meshed with said wheel gear, said cutter being inserted through said hole punch and said guide board, and said punch head set being linked with said idle gear, thus when pressing said activating board downward, said punch head set being linked through said wheel gear, said idle gear to drop simultaneously.
